(19) United States
(12) Patent Application Publication
(10) Pub. No.: US 2018/0210378 A1
(43) Pub. Date: Jul. 26, 2018

(54) PEELING GUIDE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Hiroyuki KUNUGI, Numazu Shizuoka (JP); Atsushi YAMAZOE, Fuji Shizuoka (JP); Junichi NAKAMURA, Mishima Shizuoka (JP)

(21) Appl. No.: 15/416,122

(22) Filed: Jan. 26, 2017

(51) Int. Cl. G03G 15/20

(52) U.S. Cl. CPC G03G 15/2028

(57) ABSTRACT

A peeling guide of an embodiment includes a peeling claw that comes into contact with a rotating body conveying a recording medium and separates the recording medium from the rotating body. The peeling claw including a lubricant application portion that is in contact with the rotating body and to which a lubricant is applied.

### FIELD

Embodiments described herein relate generally to a peeling guide and an image forming apparatus.

### BACKGROUND

In the related art, an image forming apparatus, such as a Multi-Function Peripheral (hereinafter, referred to as “MFP”) or a printer, is known. The image forming apparatus includes a fixing device and a peeling guide. The fixing device includes a heat roller. The heat roller conveys a recording medium. The peeling guide comes into contact with the heat roller and separates the recording medium from the heat roller. The peeling guide includes a peeling claw coming into contact with the heat roller, to ensure that the recording medium separates from the heat roller. However, a stick-and-slip phenomenon (friction and vibration phenomenon) can occur between a tip of the peeling claw and a surface of the heat roller depending on a material and a size of the peeling claw. Here, the stick-and-slip phenomenon is a phenomenon which occurs when one object slides against the other object and the objects alternately and often repeat slip past each other and/or stop (bind to each other) as a result of friction between the objects. If the stick-and-slip phenomenon occurs between the tip of the peeling claw and the surface of the heat roller, the peeling claw is elastically deformed and is vibrated, and as a result a jam such as paper jam can occur.

### DESCRIPTION OF THE DRAWINGS

FIG. 1 is a side view illustrating an example of an image forming apparatus of an embodiment.

FIG. 2 is a side view of a main portion of the image forming apparatus of the embodiment.

FIG. 3 is a view illustrating an example of a structure of a heat roller of the embodiment.

FIG. 4 is an enlarged view of a main portion of the image forming apparatus of the embodiment.

FIG. 5 is a side view of a peeling guide of the embodiment.

FIG. 6 is a front view of the peeling guide of the embodiment.

FIG. 7 is an explanatory view of a stick-and-slip phenomenon.

FIG. 8 is a diagram illustrating a relationship between a temperature and an elastic modulus of the peeling plate.

FIG. 9 is a diagram illustrating a relationship between a change in a stick-and-slip occurrence temperature and a change in a surface roughness of the heat roller due to paper feeding.

### DETAILED DESCRIPTION

A peeling guide of an embodiment includes a peeling claw that comes into contact with a rotating body conveying a recording medium and separates the recording medium from the rotating body. The peeling claw includes a lubricant application portion that is in contact with the rotating body and to which a lubricant is applied.

Hereinafter, an image forming apparatus 10 of an embodiment is explained with reference to the accompanying drawings. Moreover, in each figure, the same reference characters are given to the same configuration elements.

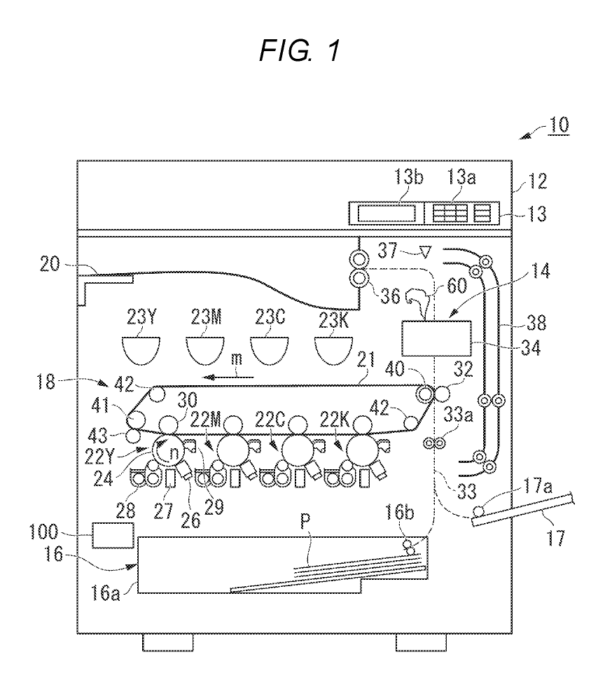

FIG. 1 is a side view illustrating an example of the image forming apparatus 10 of the embodiment. Hereinafter, a MFP 10 will be described as an example of the image forming apparatus 10.

The MFP 10 includes a scanner 12, a control panel 13, and a main portion 14. Each of the scanner 12, the control panel 13, and the main portion 14 includes a control unit. The MFP 10 includes a system control unit 100 that integrally controls each control unit. The main portion 14 includes a sheet feeding cassette portion 16, a printer portion 18, and the like.

The scanner 12 reads an image of a document. The control panel 13 includes input keys 13a and a display portion 13b. For example, the input keys 13a receive an input from a user. For example, the display portion 13b is a touch panel type display. The display portion 13b receives an input from the user and performs a display to the user.

The sheet feeding cassette portion 16 includes a sheet feeding cassette 16a and a pickup roller 16b . The sheet feeding cassette 16a stores sheets P that are the recording media. The pickup roller 16b takes out the sheet P from the sheet feeding cassette 16a.

The sheet feeding cassette 16a provides an unused sheet P. A pickup roller 17a feeds the unused sheet P stacked on a sheet feeding tray 17 to the printer portion 18.

The printer portion 18 forms an image on the sheet P. For example, the printer portion 18 forms, on the sheet P, the image read from the document by the scanner 12. The printer portion 18 includes an intermediate transfer belt 21. In the printer portion 18, a backup roller 40, a driven roller 41, and a tension roller 42 support the intermediate transfer belt 21. The backup roller 40 includes a driving portion (not illustrated). In the printer portion 18, the intermediate transfer belt 21 rotates in the direction of arrow m.

The printer portion 18 includes four image forming stations 22Y, 22M, 22C, and 22K. Each of the image forming stations 22Y, 22M, 22C, and 22K is respectively provided for forming each image of Y (yellow), M (magenta), C (cyan), and K (black). The image forming stations 22Y, 22M, 22C, and 22K are sequentially disposed on a lower side of the intermediate transfer belt 21 along a rotating direction of the intermediate transfer belt 21.

The printer portion 18 includes each of cartridges 23Y, 23M, 23C, and 23K above each of the image forming stations 22Y, 22M, 22C, and 22K. Each of the cartridges 23Y, 23M, 23C, and 23K stores each replenishing toner of Y (yellow), M (magenta), C (cyan), and K (black).

Hereinafter, the image forming station 22Y of Y (yellow), as among the image forming stations 22Y, 22M, 22C, and 22K, will be described as an example. Moreover, since the image forming stations 22M, 22C, and 22K include the same configurations as that of the image forming station 22Y, a detailed description thereof will be omitted.

The image forming station 22Y includes an electrostatic charger 26, an exposure scanning head 27, a developing device 28, and a photoreceptor cleaner 29. The electrostatic charger 26, the exposure scanning head 27, the developing device 28, and the photoreceptor cleaner 29 are disposed around a photoreceptor drum 24 which rotates in an arrow direction n.

The image forming station 22Y includes a primary transfer roller 30. The primary transfer roller 30 faces the photoreceptor drum 24 via the intermediate transfer belt 21.

The image forming station 22Y charges the photoreceptor drum 24 using the electrostatic charger 26 and then exposes the photoreceptor drum 24 using the exposure scanning head 27. The image forming station 22Y thus forms an electrostatic latent image on the photoreceptor drum 24. The developing device 28 develops the electrostatic latent image on the photoreceptor drum 24 with a two-component developer including toner and carrier.

The primary transfer roller 30 primarily transfers a toner image formed on the photoreceptor drum 24 to the intermediate transfer belt 21. The image forming stations 22Y, 22M, 22C, and 22K form a color toner image on the intermediate transfer belt 21 using the primary transfer roller 30. The color toner image is formed by subsequently superposing the toner images of Y (yellow), M (magenta), C (cyan), and K (black) on the intermediate transfer belt 21. The photoreceptor cleaner 29 removes toner remaining on the photoreceptor drum 24 after the primary transfer.

The printer portion 18 includes a secondary transfer roller 32. The secondary transfer roller 32 faces the backup roller 40 with the intermediate transfer belt 21 therebetween. As a sheet P passes between the secondary transfer roller 32 and the intermediate transfer belt 21, the color toner image on the intermediate transfer belt 21 is transferred to the sheet P. The sheet P is fed from the sheet feeding cassette portion 16 or the sheet feeding tray 17 along the conveying path 33.

The printer portion 18 includes a belt cleaner 43 facing the driven roller 41 via the intermediate transfer belt 21. The belt cleaner 43 removes toner remaining on the intermediate transfer belt 21 after the secondary transfer.

The printer portion 18 includes a registration roller 33a, a fixing device 34, and a sheet discharging roller 36 disposed along the conveying path 33. The printer portion 18 includes a peeling guide 60, a branch portion 37, and a reverse conveying portion 38 on a downstream side of the fixing device 34.

The peeling guide 60 guides the sheet P, after the image thereon is fixed, to the branch portion 37. The branch portion 37 guides the sheet P, after fixing, to the sheet discharging unit 20 or the reverse conveying portion 38. In a case of duplex printing, the reverse conveying portion 38 conveys the sheet P guided by the branch portion 37 toward the registration roller 33a. The MFP 10 makes a toner image fixed on the sheet P using the printer portion 18 and discharges the sheet P to the sheet discharging unit 20.

Moreover, the MFP 10 is not limited to a tandem developing system and the number of the developing devices 28 is also not limited to the embodiment. In addition, the MFP 10 may directly transfer the toner image onto the sheet P from the photoreceptor drum 24.

As described above, the sheet P is conveyed from the sheet feeding cassette portion 16 to the sheet discharging unit 20.

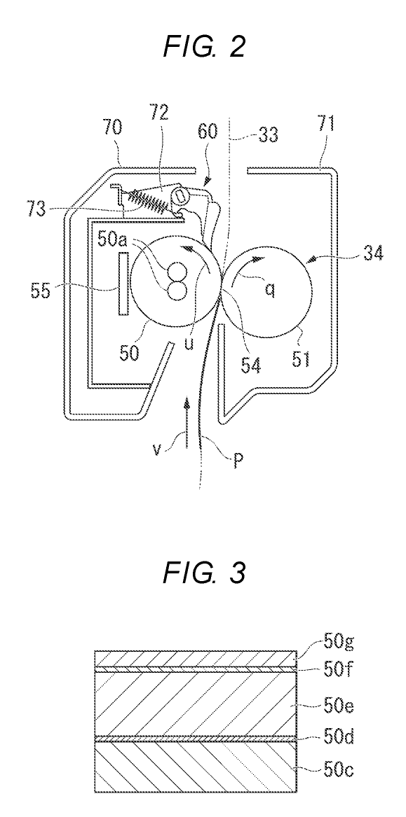

Hereinafter, a sheet feeding cassette portion 16 side is referred to as “upstream side” in a conveying direction v (see FIG. 2) of the sheet P. In addition, a sheet discharging unit 20 side is referred to as “downstream side” in the conveying direction v (see FIG. 2) of the sheet P.

Hereinafter, a main portion of the image forming apparatus 10 will be described.

FIG. 2 is a side view of the main portion of the image forming apparatus 10 of the embodiment.

First, the fixing device 34 is explained.

As illustrated in FIG. 2, the fixing device 34 includes a heat roller 50 (rotating body and heating rotating body) and a press roller 51 (pressing rotating body). The fixing device 34 fixes the toner image on the sheet P using the heat of the heat roller 50 and the pressure supplied by the pressing together of the press roller 51 and the heat roller.

The heat roller 50 is provided along the conveying path 33. The heat roller 50 is an endless rotary fixing member. The heat roller 50 has a curved outer peripheral surface. Specifically, the heat roller 50 has a cylindrical shape, and in the embodiment the heat roller 50 is a metal roller. A heat source 50a for heating the heat roller 50 is disposed inside the heat roller 50. For example, the heat source 50a is an electrical resistance heating element such as a thermal head, a ceramic heater, a halogen lamp, an electromagnetic induction heating unit, and the like. Moreover, the position of the heat source 50a is not limited to the inside of the heat roller 50, and may be disposed outside the heat roller 50.

A temperature sensor 55 is disposed in the vicinity of the fixing device 34. The temperature sensor 55 detects a temperature of the fixing device 34. Specifically, the temperature sensor 55 faces the heat roller 50. For example, the temperature sensor 55 is a thermistor. The temperature sensor 55 detects the surface temperature of the heat roller 50. A detection result (surface temperature of the heat roller 50) of the temperature sensor 55 is output to the system control unit 100 (see FIG. 1). The system control unit 100 controls the output of the heat source 50a such that the surface temperature of the heat roller 50 is maintained at a predetermined temperature (for example, 140° C. to 150° C.) using the detection result of the temperature sensor 55.

Moreover, the heat roller 50 may have a multilayer structure.

FIG. 3 is a view illustrating an example of a structure of the heat roller 50 of the embodiment.

As illustrated in FIG. 3, the heat roller 50 includes a base layer 50c, a first adhesive layer 50d, an elastic layer 50e, a second adhesive layer 50f, and a release layer 50g.

The base layer 50c is disposed on an inner periphery side of the heat roller 50. For example, the base layer 50c is a metal base material such as aluminum that is excellent in thermal conductivity. The base layer 50c is made of aluminum and thereby heat is easily conducted to the sheet P.

The first adhesive layer 50d causes an outer peripheral surface of the base layer 50c to adhere to an inner peripheral surface of the elastic layer 50e.

The thickness of the elastic layer 50e is thicker than the thickness of the base layer 50c. For example, the elastic layer 50e is made of rubber or the like. The heat roller 50 includes the elastic layer 50e and thereby it is possible to uniformly press the sheet P and sufficiently ensure image quality.

The second adhesive layer 50f causes an outer peripheral surface of the elastic layer 50e to adhere to an inner peripheral surface of the release layer 50g.

The release layer 50g is disposed on the outer periphery side of the heat roller 50. A thickness of the release layer 50g is thinner than the thickness of the base layer 50c. For example, the release layer 50g is formed of fluororesin such as tetrafluoroethylene-perfluoroalkyl vinyl ether copolymer resin (PFA). For example, the release layer 50g is formed of a PFA tube having a thickness of 20 μm to 30 μm. The release layer 50g is made of fluororesin and thereby it is possible to sufficiently ensure releasing property of the sheet P.

Moreover, a belt or a film may be used instead of the heat roller 50.

Next, the press roller 51 will be described.

As illustrated in FIG. 2, the press roller 51 is a pressing member which presses the sheet P against heat roller 50. For example, the press roller 51 comprises a heat-resistant silicon sponge structure, a heat-resistant silicon rubber layer, and the like, located around a core metal. For example, a release layer is disposed on a surface of the press roller 51. The release layer is formed of a fluorine-based resin such as the PFA resin. The press roller 51 presses a sheet P against the heat roller 50 using a pressing mechanism to bias the press roller in the direction of the heat roller 50 (not illustrated).

The heat roller 50 is rotated by a motor (not illustrated) in the direction of arrow u. The press roller 51 is rotated in the direction of arrow q by being driven by the heat roller 50 when the heat roller 50 abuts against the press roller 51. The heat roller 50 is rotated in the direction of arrow u by the motor when the heat roller 50 is away from the press roller 51. Moreover, the press roller 51 may have a separate driving source independent of the heat roller 50.

The sheet P passes through a nip 54 between the heat roller 50 and the press roller 51 along the conveying path 33. The peeling guide 60 is provided on a downstream side of the fixing device 34 in the conveying direction v of the sheet P. The peeling guide 60 is disposed on the downstream side of the heat roller 50 and an upstream side of the sheet discharging unit 20 (see FIG. 1). The peeling guide 60 initially comes into contact with the sheet P after the image thereon has been fixed. A plurality (for example, five even though not illustrated) of peeling guides 60 are disposed which are spaced apart in a width direction (hereinafter, referred to as “roller width direction”) of the heat roller 50. Here, the roller width direction corresponds to an rotational axis direction of the heat roller 50 that is the rotating body.

For example, intervals of the peeling guides 60 in the roller width direction are set according to a size of the sheet P. The plurality of peeling guides 60 are spaced apart in the roller width direction and thereby it is possible to further reliably peel the sheet P from the heat roller 50.

Moreover, in FIG. 2, reference numerals 70 and 71 indicate frames for supporting the fixing device 34. Reference numeral 72 indicates a support member which is mounted on the MFP frame 70.

Next, the peeling guide 60 will is explained.

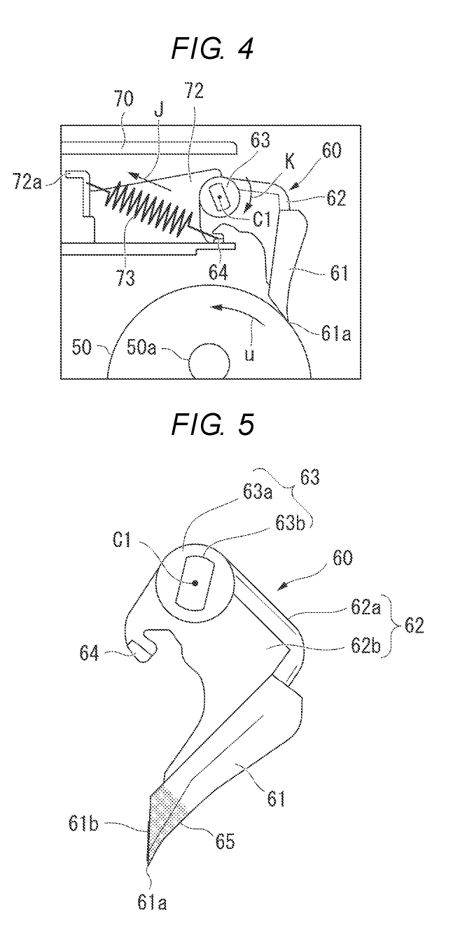

FIG. 4 is an enlarged view of a main portion of the image forming apparatus 10 of the embodiment.

As illustrated in FIG. 4, the peeling guide 60 separates the sheet P (see FIG. 2) from the heat roller 50 by coming into contact with the heat roller 50. The peeling guide 60 includes a peeling claw 61 which comes into contact with the heat roller 50. The peeling claw 61 has a pointed shape protruding toward the heat roller 50 side thereof. A tip 61a of the peeling claw 61 comes into contact with the surface of the heat roller 50. The tip 61a of the peeling claw 61 causes the sheet P, after fixing, to not stick to the heat roller 50. The tip 61a of the peeling claw 61 enters a gap between a leading edge of the sheet P and the surface of the heat roller 50 and as a wedge, separates the sheet P from the heat roller 50.

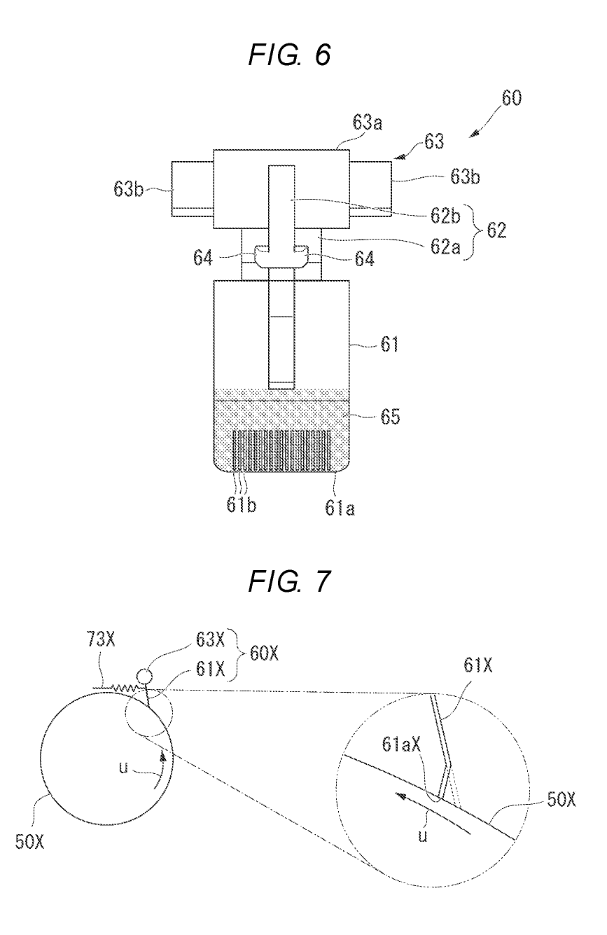

FIG. 5 is a side view of the peeling guide 60 of the embodiment. FIG. 6 is a front view of the peeling guide 60 of the embodiment.

As illustrated in FIG. 5, the peeling guide 60 includes the peeling claw 61, a connecting portion 62, a supporting shaft portion 63, an engaging portion 64, and a lubricant application portion 65. The peeling claw 61, the connecting portion 62, the supporting shaft portion 63, and the engaging portion 64 are integrally formed of the same material. For example, the material of the peeling guide 60 is PFA, and the material of the peeling claw 61 is PFA.

As illustrated in FIG. 6, the peeling claw 61 has a longitudinal side in the conveying direction v (see FIG. 2) of the sheet P. The peeling claw 61 has a lateral side in the roller width direction.

A plurality (for example, 16 in the embodiment as shown in FIG. 6) of ribs 61b are formed in the peeling claw 61. The plurality of ribs 61b are disposed on a tip 61a side of the peeling claw 61. The ribs 61b protrude toward the heat roller 50 (see FIG. 4) side. For example, a protrusion height of the rib 61b is approximately 50 μm from the surface of the peeling claw 61. The rib 61b has a longitudinal side in the conveying direction v (see FIG. 2) of the sheet P. The rib 61b has a lateral side in the roller width direction. For example, a width of the rib 61b on the lateral side is 0.1 mm to 1 mm. Intervals between adjacent two ribs 61b have substantially the same size. As a result of the use of the ribs 61b, the contact area between the peeling claw 61 and the heat roller 50 is reduced.

A surface roughness or pattern (not illustrated) is formed on a surface of the peeling claw 61. Surface roughness (not illustrated) is also formed on a surface of the rib 61b. For example, as a method for forming the surface roughness or pattern, the following methods may be employed:
The surface of the peeling claw 61 is roughened using a file.
Embossing is performed on an inner surface of a molding die of the peeling claw 61 and the embossed pattern is transferred to the surface of the peeling claw 61 simultaneously with the forming of the peeling claw 61.
Blasting is performed on the surface of the peeling claw 61 to roughen the surface.
Fine surface roughness is added on the surface of the peeling claw 61 using a laser device such as a laser ablation device.
A chemical treatment such as an etching treatment is performed on the surface of the peeling claw 61.

Whether the surface roughness or pattern is added using any method can be appropriately selected. Herein, surface roughness is used to denote both a random surface roughness, such as that attained by filing or blasting the surface of the peeling claw 61, as well as a regular three dimensional pattern as can be achieved by transferring an embossed mold pattern to the claw 61 or by laser ablation of the surface thereof.

The surface roughness has an Ra 1.0 or more and Ra 2.0 or less. A lubricant is at least temporarily retained by the valleys (recessed portions) of the surface roughness. From the viewpoint of sufficiently holding the lubricant in a recessed portions of the surface roughness, it is preferable that the surface roughness has an Ra 1.1 or more and Ra 2.0 or less. Moreover, the surface roughness is measured based on an arithmetic average roughness as set forth in JIS standard (JIS B0601 2001).

Next, the connecting portion 62 will be described.

As illustrated in FIG. 5, the connecting portion 62 connects the peeling claw 61, the supporting shaft portion 63, and the engaging portion 64. The connecting portion 62 includes a first connecting portion 62a and a second connecting portion 62b.

The first connecting portion 62a connects the peeling claw 61 and the supporting shaft portion 63. The first connecting portion 62a has an L-shape having the convex side thereof facing toward the conveying path 33 (see FIG. 2) side when viewed from the roller width direction. As illustrated in FIG. 6, the width of the first connecting portion 62a is smaller than the width of the peeling claw 61 in the roller width direction. The first connecting portion 62a is disposed at a center of the peeling claw 61 and the supporting shaft portion 63 in the roller width direction.

As illustrated in FIG. 5, the second connecting portion 62b connects the peeling claw 61, the supporting shaft portion 63, and the engaging portion 64. The second connecting portion 62b has a shape along the peeling claw 61 and the first connecting portion 62a so as to fill the space between the peeling claw 61 and the supporting shaft portion 63 when viewed from the roller width direction. As illustrated in FIG. 6, the width of the second connecting portion 62b is smaller than the width of the first connecting portion 62a in the roller width direction. The second connecting portion 62b is disposed at the center of the first connecting portion 62a in the roller width direction.

Next, the supporting shaft portion 63 will be described.

The supporting shaft portion 63 has a longitudinal side in the roller width direction. The supporting shaft portion 63 is disposed to avoid the conveying path 33 (see FIG. 2). The supporting shaft portion 63 includes a base portion 63a and supporting shaft end portions 63b.

The base portion 63a has a cylindrical shape having a longitudinal side in the roller width direction. A length of the base portion 63a is substantially the same length as the width of the peeling claw 61 in the roller width direction.

The supporting shaft end portions 63b are provided at both ends of the base portion 63a in the longitudinal direction. As illustrated in FIG. 5, the supporting shaft end portions 63b form a pivot point C1 of the peeling guide 60. The outer circumference of the supporting shaft end portion 63b is smaller than the outer circumference of the base portion 63a when viewed from the roller width direction. The supporting shaft end portion 63b has two linear long sides when viewed from the roller width direction. The supporting shaft end portion 63b is formed of two circular short sides extending from the sides of the base portion 63a when viewed from the roller width direction. The supporting shaft end portion 63b is rotatably supported on a supporting shaft supporting portion (not illustrated) of a support member 72 (see FIG. 4).

Next, the engaging portion 64 will be described.

As illustrated in FIG. 6, the engaging portion 64 is a claw portion that protrudes from both sides of the second connecting portions 62b in the roller width direction. As illustrated in FIG. 4, a biasing member 73 is connected to the engaging portion 64. For example, the biasing member 73 is a coil spring. Specifically, one end portion of the biasing member 73 is engaged with the engaging portion 64. The other end portion of the biasing member 73 is engaged with an engaging portion 72a of the support member 72. The biasing member 73 biases the peeling guide 60 in the direction of arrow j. The peeling guide 60 is rotated in the direction of arrow K (clockwise direction) around the pivot point C1 by a biasing force of the biasing member 73. That is, the biasing member 73 biases the peeling guide 60 in a direction in which the peeling guide 60 approaches the heat roller 50. The tip 61a of the peeling claw 61 abuts against the surface of the heat roller 50 as a result of the biasing force of the biasing member 73.

Next, the lubricant application portion 65 will be described.

As illustrated in FIG. 5, the lubricant application portion 65 is a portion for applying the lubricant to a contact portion between the heat roller 50 (see FIG. 4) and the peeling claw 61. The lubricant application portion 65 is disposed to avoid the conveying path 33 (see FIG. 2). In FIGS. 5 and 6, a forming region (application region of the lubricant) of the lubricant application portion 65 is shaded. For example, the lubricant application portion 65 is formed by immersing the tip of the peeling claw 61 into a lubricant that is stored in a bath. Surface roughness (not illustrated) and the plurality of ribs 61b are formed in the lubricant application portion 65 in the peeling claw 61.

The lubricant is a dry film lubricant. The dry film lubricant is a quick-drying volatile type. Here, the quick-drying volatile type means a type in which a liquid component of the lubricant is volatilized after a few tens of seconds of exposure to the atmosphere. The dry film lubricant is a fluorine-based material. Here, fluorine-based means a type that it contains fluorine oil having a mass percent of approximately 5 wt %. Moreover, the dry film lubricant may contain a solid material (solid lubricant) having a self-lubricating property. For example, as the solid lubricant, graphite, molybdenum disulfide, polytetrafluoroethylene (PTFE), and the like are exemplified. In the embodiment, as the lubricant, a dry film lubricant (article name “HANARL” and model number “TT-1013”) made by Kanto Kasei Corporation is used.

In the embodiment, the thickness (in other words, the thickness of the application film) of the lubricant applied to the lubricant application portion 65 is a thickness which is dispersed or worn away until the tip 61a of the peeling claw 61 runs in with the surface of the heat roller 50. That is, the lubricant application portion 65 is worn off such that the tip 61a of the peeling claw 61 runs in with the surface of the heat roller 50. Therefore, the lubricant may run out in the peeling claw 61. For example, the duration of the effect of the lubricant application portion 65 to prevent the stick and slip phenomenon is ensured until 100 to 1000 sheets P have passed through the nip 54.

Moreover, in the embodiment, the lubricant is not applied to the heat roller 50 but is applied to the peeling claw 61. According to the embodiment, it is possible to suppress an influence of the lubricant on image quality compared to a case where the lubricant is applied to the heat roller 50.

FIG. 7 is an explanatory view of the stick-and-slip phenomenon. In FIG. 7, reference numeral 50X is a heat roller, reference numeral 60X is a peeling guide, reference numeral 61X is a peeling claw, reference numeral 63X is a supporting shaft portion, and reference numeral 73X is a biasing member.

As illustrated in FIG. 7, the heat roller 50X is rotated in the direction of arrow u. The tip 61aX of the peeling claw 61X abuts against the surface of the heat roller 50X with a biasing force supplied by the biasing member 73X. The stick-and-slip phenomenon is generated by the tip 61aX of the peeling claw 61X alternately slipping (sliding along the roller surface) and stopping (shucking to the roller surface) of due to friction when the tip 61aX of the peeling claw 61X contacts the surface of the heat roller 50X.

Moreover, the enlarged view of FIG. 7 illustrates a state of the tip of the peeling claw 61X in which relative motion between the roller and the tip 61aX of the peeling claw 61X indicated by a solid line is stopped by the friction (state where the tip of the peeling claw 61X is elastically deformed and it sticks to the roller surface). Meanwhile, the dashed outline of the peeling claw 61X shown in the enlarged view of FIG. 7 illustrates a state of the tip of the peeling claw 61X where the tip 61aX of the peeling claw 61X slips along the surface of the heat roller 50X.

As described above, if the stick-and-slip phenomenon occurs between the tip 61aX of the peeling claw 61X and the surface of the heat roller 50X, the peeling claw 61X is repeatedly elastically deformed and fine vibration occurs. Therefore, a jam such as paper jam may occur.

According to the embodiment, the peeling claw 61 and the lubricant application portion 65 are provided. The peeling claw 61 comes into contact with the heat roller 50 conveying the sheet P and separates the sheet P from the heat roller 50. The lubricant application portion 65 is a portion whereby the lubricant is applied to the contact location between the heat roller 50 and the peeling claw 61. With the configuration described above, the following effects are achieved. It is possible to suppress a friction force between the tip 61a of the peeling claw 61 and the surface of the heat roller 50 to a small value by using the lubricant application portion 65. Therefore, it is possible to suppress occurrence of the stick-and-slip phenomenon between the tip 61a of the peeling claw 61 and the surface of the heat roller 50. Thus, it is possible to suppress the occurrence of a jam such as paper jam.

In addition, when the tip 61a of the peeling claw 61 comes into contact with the surface of the heat roller 50, it is possible to suppress scratches on the surface of the heat roller 50 by the use of the lubricant application portion 65. Therefore, it is possible to suppress deterioration of the image quality. Particularly, in a color printing machine emphasizing the image quality, it is possible to effectively suppress deterioration of the image quality.

Meanwhile, from the viewpoint of suppressing deterioration of the image quality, it is possible to adopt a peeling plate of non-contact peeling type. However, in order to prevent sticking of toner to the peeling plate, since coating is applied or a fluorine-based tape is attached, that may result a high-cost. In order to avoid the high-cost due to coating, tape attachment, and the like, it is possible to adopt a soft material for the peeling plate of a contact peeling type. On the other hand, in order to reduce a contact pressure between the peeling plate and the heat roller, it is also possible to increase the width of the contact portion with the heat roller in the roller width direction of the peeling plate. However, since a contact area between the peeling plate and the heat roller is increased, that will increase the frictional forces between the peeling plate and the heat roller. If the friction based force between the peeling plate and the heat roller is increased, the tip of the peeling plate is likely to follow the rotation of the heat roller, i.e. stick. Therefore, a possibility of occurrence of the stick-and-slip phenomenon between the peeling plate and the heat roller is increased.

Furthermore, in order to fix toner to the sheet, if a surface temperature of the heat roller is increased to a predetermined temperature, the temperature of the portion of the peeling plate coming into contact with the surface of the heat roller is also increased. If the temperature of the peeling plate is increased, the elastic modulus of the peeling plate is lowered. Then, since the peeling plate with a lower modulus is more easily deformed, the possibility of the occurrence of the stick-and-slip phenomenon between the peeling plate and the heat roller is increased.

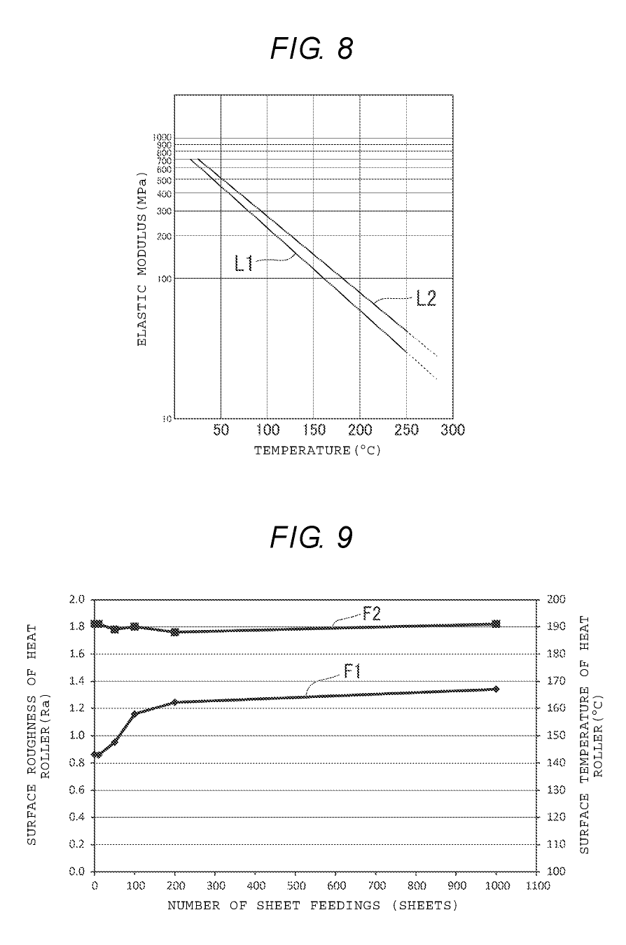

FIG. 8 is a diagram illustrating a relationship between the temperature and the elastic modulus of the peeling plate. Here, the elastic modulus means a flexural modulus. In FIG. 8, a horizontal axis indicates the temperature (° C.) of the peeling plate and a vertical axis indicates the elastic modulus (MPa) of the peeling plate. Reference numeral L1 indicates a peeling plate (hereinafter, referred to as “low specific gravity peeling plate”) that is formed of PFA having a specific gravity of 2.140 and reference numeral L2 indicates a peeling plate (hereinafter, referred to as “high specific gravity peeling plate”) that is formed of PFA having a specific gravity of 2.169. Moreover, the peeling plate simply referred to as “PFA peeling plate” is a case where the low specific gravity peeling plate and the high specific gravity peeling plate are not particularly distinguished.

As illustrated in FIG. 8, the elastic modulus of the low specific gravity peeling plate L1 is lower than that of the high specific gravity peeling plate L2. The temperature and the elastic modulus of the PFA peeling plate have a proportional relationship. In a peeling plate formed of PFA, the elastic modulus decreases as the temperature increases. That is, the possibility of occurrence of the stick-and-slip phenomenon between the PFA peeling plate and the surface of the heat roller is increased as the temperature thereof becomes higher.

Meanwhile, as a countermeasure to the stick-and-slip phenomenon, there is a method in which the tip of the peeling plate is polished and a friction force between the peeling plate and the heat roller is suppressed. However, the possibility of occurrence of the stick-and-slip phenomenon between the peeling plate and the heat roller may not be suppressed by merely polishing the tip of the peeling plate due to polishing variations.

According to the embodiment, since coating, tape attachment, and the like are not needed as in the peeling plate of the non-contact peeling type, it is possible to achieve simplification and a low-cost of the peeling guide 60. In addition, there is not the problem of polishing variation by providing the lubricant application portion 65 as in a case where the tip of the peeling plate is polished. Therefore, it is possible to reliably suppress the occurrence of the stick-and-slip phenomenon between the tip 61a of the peeling claw 61 and the surface of the heat roller 50.

The lubricant is the dry film lubricant and thereby the following effects are achieved. Meanwhile, the lubricant is also contemplated to be silicone-based lubricant. However, since the silicone-based lubricant has high viscosity and is a liquid, the silicone-based lubricant applied to the peeling claw may adhere to the heat roller when the peeling claw comes into contact with the heat roller. Furthermore, the silicone-based lubricant adhered to the heat roller is transferred to the sheet and thereby the image quality may be lowered. According to the embodiment, the dry film lubricant has low viscosity and is a solid in contrast to the silicone-based lubricant. Therefore, when the peeling claw 61 comes into contact with the heat roller 50, it is possible to suppress adhesion of the dry film lubricant applied to the peeling claw 61 to the heat roller 50. Therefore, since the transfer of the dry film lubricant to the sheet P is suppressed, it is possible to suppress deterioration in an image quality of printed images.

The dry film lubricant is the quick-drying volatile type and thereby the following effects are achieved. Since the liquid component of the lubricant is volatilized after a few tens of seconds elapse, it is possible to quickly form the lubricant application portion 65.

The dry film lubricant is the fluorine-based and thereby the following effects are achieved. Meanwhile, the dry film lubricant is also contemplated to be a completely dry type or oil-less. However, if the dry film lubricant is the completely dry type, since the completely dry type is likely to wear due to friction between the peeling claw 61 and the heat roller 50, it is not possible to sufficiently ensure the effect duration of the lubricant application portion 65. According to the embodiment, since the fluorine-based lubricant is unlikely to wear off due to the friction between the peeling claw 61 and the heat roller 50 in contrast to the completely dry type, it is possible to sufficiently ensure the effect duration of the lubricant application portion 65. In addition, since the lubricant application portion 65 contains fluorine oil and has a self-lubricating property, it is possible to cause the friction force between the tip 61a of the peeling claw 61 and the surface of the heat roller 50 to be even smaller. Therefore, it is possible to further reliably suppress the occurrence of the stick-and-slip phenomenon between the tip 61a of the peeling claw 61 and the surface of the heat roller 50.

The surface roughness is formed in the lubricant application portion 65 in the peeling claw 61 and thereby the following effects are achieved. It is possible to reduce the contact area between the peeling claw 61 and the heat roller 50 compared to a case where a width of the contact portion with the heat roller in the roller width direction is simply increased in the peeling plate. Therefore, it is possible to further reduce the friction forces between the peeling claw 61 and the heat roller 50. Thus, the tip 61a of the peeling claw 61 is unlikely to follow the rotation of the heat roller 50. Therefore, it is possible to effectively suppress the occurrence of the stick-and-slip phenomenon between the tip 61a of the peeling claw 61 and the surface of the heat roller 50. In addition, since the lubricant can be held in recessed portions and transported to the contact location of the tip 61a with the heat roller 50 by the capillary phenomenon of the surface roughness, it is easy to suppress the friction force between the tip 61a of the peeling claw 61 and the surface of the heat roller 50 compared to a case where the lubricant application portion 65 is a flat surface. Particularly, if the dry film lubricant is the fluorine-based lubricant, since the lubricant is easily held in the recessed portions of the surface roughness, the friction forces between the tip 61a of the peeling claw 61 and the surface of the heat roller 50 is easily suppressed to be even smaller. In addition, it is possible to sufficiently ensure the effect duration of the lubricant application portion 65. Meanwhile, if the material of the peeling claw 61 is PFA, the releasing property is high and the material is not thermally suitable for coating. According to the embodiment, even if the material of the peeling claw 61 is PFA, since it is possible to maintain the lubricant in the recessed portions by the capillary phenomenon of the surface roughness, the material is suitable for the claw 61.

The surface roughness has an Ra 1.0 or more and an Ra 2.0 or less and thereby the following effects are achieved. If the unevenness has an Ra less than 1.0 or an Ra exceeding 2.0, the lubricant may not be sufficiently held in the recessed portions of the surface roughness. According to the embodiment, it is possible to hold the lubricant in the recessed portions due to the capillary phenomenon of the fine surface roughness. Therefore, it is easy to suppress the friction forces between the tip 61a of the peeling claw 61 and the surface of the heat roller 50 compared to a case where the surface roughness has an arithmetic average roughness outside the range described above.

The material of the peeling claw 61 is PFA and thereby the following effects are achieved. Since the releasing property of the peeling claw 61 is improved, it is possible to reduce adhesion of the toner to the peeling claw 61. Therefore, toner adhered to the peeling claw 61 is not transferred to the sheet P and it is possible to suppress deterioration in an image quality of printing images.

Meanwhile, the possibility of the occurrence of the stick-and-slip phenomenon between the peeling plate made of PFA and the surface of the heat roller is increased as the temperature of the peeling claw 61 becomes higher. According to the embodiment, even if the peeling claw 61 is made of PFA, since it is possible to suppress the occurrence of the stick-and-slip phenomenon between the tip 61a of the peeling claw 61 and the surface of the heat roller 50, the peeling claw 61 is suitable for the high temperatures.

The lubricant application portion 65 is disposed to avoid the conveying path 33 and thereby the following effects are achieved. It is possible to avoid adhesion of the lubricant to the sheet P during conveyance of the sheet P compared to a case where the lubricant application portion 65 is disposed in the conveying path 33.

The ribs 61b are formed in the lubricant application portion 65 of the peeling claw 61 and thereby the following effects are achieved. It is possible to reduce the contact area between the peeling claw 61 and the heat roller 50 compared to a case where the width of the contact portion with the heat roller in the roller width direction in the peeling plate is simply increased. Therefore, it is possible to reduce the friction force between the peeling claw 61 and the heat roller 50. Thus, the tip 61a of the peeling claw 61 is unlikely to follow the rotation of the heat roller 50. Therefore, it is possible to effectively suppress the occurrence of the stick-and-slip phenomenon between the tip 61a of the peeling claw 61 and the surface of the heat roller 50.

The thickness of the lubricant in the lubricant application portion 65 is a thickness up to when the tip 61a of the peeling claw 61 runs in with the surface of the heat roller 50 and thereby the following effects are achieved. It is possible to suppress the friction force between the tip 61a of the peeling claw 61 and the surface of the heat roller 50 by the lubricant application portion 65 until the tip 61a of the peeling claw 61 runs in with the surface of the heat roller 50. The friction force between the tip 61a of the peeling claw 61 and the surface of the heat roller 50 is reduced after the tip 61a of the peeling claw 61 runs in with the surface of the heat roller 50, as the surface of the heat roller 50 becomes smoother, and the coefficient of friction thereof lowers, during the run in period. Therefore, it is possible to effectively suppress the occurrence of the stick-and-slip phenomenon between the tip 61a of the peeling claw 61 and the surface of the heat roller 50, both initially when the contacting surfaces have higher friction, and after run in after the lubricant may have become exhausted or worn away. Thus, the lubricant can be used up and replenishment of the lubricant is not required. Therefore, the time and labor needed to replenish the lubricant is avoided.

The image forming apparatus 10 includes the peeling guide 60 and thereby the following effects are achieved. It is possible to suppress occurrence of the stick-and-slip phenomenon between the tip 61a of the peeling claw 61 and the surface of the heat roller 50. Therefore, it is possible to suppress occurrence of jam such as paper jam.

As a result of intensive studies of the inventors of the present application, it is found that conditions of the occurrence of the stick-and-slip phenomenon between the tip of the peeling claw and the surface of the heat roller are provided when the following two conditions are simultaneously satisfied.
The heat roller is an unused (new) product and the surface of the heat roller is not roughened.
The surface temperature of the heat roller is high (150° C. or more).

Furthermore, the inventors of the present application found the following points.
Even if the lubricant (“HANARL” described above) is not applied to the peeling claw (hereinafter, the “non-application product”), if the surface roughness of the heat roller has Ra 1.1 or more, the stick-and-slip phenomenon does not occur.
In case of the non-application product, the surface temperature (hereinafter, referred to as “stick-and-slip phenomenon occurrence temperature”) of the heat roller when the stick-and-slip phenomenon occurs is approximately 154° C.
In a case of the peeling claw to which the lubricant (“HANARL” described above) is applied (hereinafter, referred to as “application product”), the stick-and-slip phenomenon occurrence temperature is approximately 190° C.

Moreover, normally, the surface temperature of the heat roller is controlled to 140° C. to 150° C. However, if the sheet size is a small size such as A5R, since temperatures of the end portions of the heat roller in the roller width direction are increased at the time of paper feeding, the surface temperature of the heat roller reaches approximately 168° C.

As described above, if the stick-and-slip phenomenon occurrence temperature is not less than 168° C. when the surface of the heat roller is roughed to Ra 1.1 or more due to paper feeding, the stick-and-slip phenomenon does not occur.

FIG. 9 is a diagram illustrating a relationship between a change in the stick-and-slip occurrence temperature and a change in the surface roughness of the heat roller due to paper feeding. In FIG. 9, a horizontal axis indicates the number of paper feedings (sheets) of A4 sheet, a vertical axis on a left side includes the surface roughness (Ra) of the heat roller, and a vertical axis on a right side indicates the surface temperature (° C.) of the heat roller. Reference numeral F1 indicates the surface roughness of the heat roller and reference numeral F2 indicates the stick-and-slip phenomenon occurrence temperature of the application product.

As illustrated in FIG. 9, if approximately 100 sheets of the A4 sheet are fed, the surface roughness F1 of the heat roller becomes approximately Ra 1.1. Therefore, from the viewpoint of suppressing the occurrence of the stick-and-slip phenomenon, the stick-and-slip phenomenon occurrence temperature is not less than 168° C. once approximately 100 sheets of the A4 sheet are fed.

Even after approximately 1000 sheets are fed, the application product maintains the stick-and-slip phenomenon occurrence temperature F2 at approximately 190° C. Therefore, according to the application product, it can be seen that it is possible to suppress the occurrence of the stick-and-slip phenomenon.

Hereinafter, modification examples will be described.

The fixing device 34 is not limited to the configuration in which the heat source is provided in the heat roller 50. For example, the heat source may be disposed on the press roller 51 side.

The fixing device 34 is not limited to the lamp heating system. For example, the fixing device 34 may be an electromagnetic induction heating system (IH system) for electromagnetic induction heating the conductive layer of the belt.

The surface roughness is formed in the lubricant application portion 65 in the peeling claw 61 but is not limited to the example. For example, surface roughness having Ra 1.0 or more and Ra 2.0 or less may be formed on the surface of the heat roller 50. From the viewpoint of suppressing the occurrence of the stick-and-slip phenomenon, it is preferable that the surface roughness of the surface of the heat roller 50 has Ra 1.1 or more and Ra 2.0 or less.

According to at least one embodiment described above, the peeling claw 61 and the lubricant application portion 65 are provided. The peeling claw 61 separates the sheet P from the heat roller 50 by coming into contact with the heat roller 50 conveying the sheet P. The lubricant application portion 65 is a portion where the lubricant is applied to the contact portion with the heat roller 50 in the peeling claw 61. With the configurations described above, the following effects are achieved. It is possible to suppress the friction force small between the tip 61a of the peeling claw 61 and the surface of the heat roller 50 by the lubricant application portion 65. Therefore, it is possible to suppress the occurrence of the stick-and-slip phenomenon between the tip 61a of the peeling claw 61 and the surface of the heat roller 50. Therefore, it is possible to suppress occurrence of jam such as paper jam.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. A peeling guide comprising:
a peeling claw that comes into contact with a rotating body for heating and conveying a recording medium, the peeling claw shaped and positioned to separate the recording medium from the rotating body, the peeling claw including a lubricant application portion to which a lubricant is applied and a tip that is in contact with the rotating body, wherein the lubricant application portion has a surface with a surface roughness value that maximizes adhesion of the lubricant to the lubricant application portion.

2. The guide according to claim 1,
wherein the lubricant is a dry film lubricant.

3. The guide according to claim 2,
wherein the dry film lubricant is a volatile type lubricant.

4. The guide according to claim 2,
wherein the dry film lubricant is a fluorine-based lubricant.

5. The guide according to claim 1,
wherein the surface roughness is formed in the portion of the peeling claw that is in contact with the rotating body.

6. The guide according to claim 5,
wherein the surface roughness is not less than Ra 1.0 μm and not greater than Ra 2.0 μm.

7. The guide according to claim 1,
wherein a material of the peeling claw is PFA.

8. The guide according to claim 1,
wherein the lubricant application portion is located outside of the conveying path of a recording media.

9. The guide according to claim 1,
wherein ribs are formed in the lubricant application portion.

10. The guide according to claim 1,
wherein the interval between any two adjacent ribs have the same size.

11. An image forming apparatus comprising:
an image forming device that forms an image on a recording medium;
a fixing device that has a heated rotating body and a pressing rotating body and fixes the image that is formed on the recording medium by the image forming unit, to the recording medium; and
a peeling claw that has a tip portion that comes into contact with the heated rotating body and a lubricant application portion to which a lubricant is applied, wherein the lubricant application portion has a surface with a surface roughness value that maximizes adhesion of the lubricant to the lubricant application portion.

12. The apparatus according to claim 11,
wherein the lubricant is a dry film lubricant.

13. The guide according to claim 12,
wherein the dry film lubricant is a volatile type lubricant.

14. The apparatus according to claim 12,
wherein the dry film lubricant is a fluorine-based lubricant.

15. The apparatus according to claim 11,
wherein the surface roughness is formed in the contact portion where the lubricant is applied.

16. The apparatus according to claim 15,
wherein the surface roughness is not less than Ra 1.0 μm and not greater than Ra 2.0 μm.

17. The apparatus according to claim 11,
wherein a material of the peeling claw is PFA.

18. The apparatus according to claim 11,
wherein the contact portion where the lubricant is applied is located outside of the conveying path of a recording media.

19. The apparatus according to claim 11,
wherein ribs are formed in the contact portion.

20. The apparatus according to claim 11,
wherein the interval between any two adjacent ribs have the same size.
